(19) United States
(12) Patent Application Publication
(10) Pub. No.: US 2026/0086645 A1
(43) Pub. Date: Mar. 26, 2026

(54) POSE-BASED HAPTIC FEEDBACK FOR ELECTRONIC POINTING DEVICES

(71) Applicant: Apple Inc., Cupertino, CA (US)

(72) Inventors: Benjamin R. BLACHNITZKY, San Francisco, CA (US); Nicolai GEORG, San Francisco, CA (US); Carmine ELVEZIO, San Francisco, CA (US); Arun Rakesh YOGANANDAN, San Francisco, CA (US); Matthew J. SUNDSTROM, Campbell, CA (US)

(21) Appl. No.: 19/337,404

(22) Filed: Sep. 23, 2025

Related U.S. Application Data
(60) Provisional application No. 63/699,128, filed on Sep. 25, 2024.

(51) Int. Cl. G06F 3/01; G06F 3/0346

(52) U.S. Cl. CPC G06F 3/016; G06F 3/017; G06F 3/0346; G06F 2203/014

(57) ABSTRACT

Some examples of the disclosure are directed to systems and methods for generating a haptic feedback response at an electronic pointing device based on the pose of one or more hands of the user. In one or more examples, an electronic device (e.g., computing system) has an electronic pointing device that is communicatively coupled (e.g., wired and/or wirelessly) to the electronic device and is configured to receive commands from the electronic to generate haptic feedback (e.g., vibration) patterns based on a detected pose of one or more hands of the user of the electronic pointing device.

### CROSS-REFERENCE TO RELATED APPLICATIONS

This application claims the benefit of U.S. Provisional Application No. 63/699,128, filed Sep. 25, 2024, the content of which is incorporated herein in its entirety for all purposes.

### FIELD OF THE DISCLOSURE

This relates generally to systems and methods for generating haptic feedback at an electronic point device based on the pose of an input element.

### BACKGROUND OF THE DISCLOSURE

Some computer systems include cameras configured to capture images and/or video. Some computer systems, using the cameras, display three-dimensional environment that include representations of physical real-world objects as well as virtual objects.

### SUMMARY OF THE DISCLOSURE

Some examples of the disclosure are directed to systems and methods for generating a haptic feedback response at an electronic pointing device based on the pose of one or more hands of the user. In one or more examples, an electronic device (e.g., computing system) has an electronic pointing device that is communicatively coupled (e.g., wired and/or wirelessly) to the electronic device and is configured to receive commands from the electronic to generate haptic feedback (e.g., vibration) patterns based on a detected pose of one or more hands of the user of the electronic pointing device.

In some examples, the pose of the hands of the user includes the location on the electronic pointing device where the hand is holding the pointing device. In some examples, the location of where the hand is holding the electronic pointing device is based on a sensor that is located on the electronic pointing device. Additionally or alternatively, the location is determined using one or more cameras associated with the electronic device that are configured to track the hands of the user. In some examples, the pose of the hands of the user includes an orientation of the hand when it is holding the electronic pointing device, which is optionally determined based on the one or more cameras associated with the electronic device that are configured to track the hands of the user. In some examples, the pose of the hand of the user includes the amount of force that the hand is applying to the electronic pointing device. Optionally, the force is determined using one or more force sensors that are located within the electronic pointing device. In some examples, the pose of the hands of the user includes a location and orientation of the hand of the user that is not holding the electronic pointing device.

In some examples, the haptic response generated by the electronic pointing device includes a stereo haptic effect that is generated on one or more ends of the electronic pointing device. In some examples, the stereo haptic is based on the location on the electronic pointing device where the hand is holding the device. In some examples, the stereo haptic effect includes a vibration pattern that is based on the pose of the hand. In some examples, the haptic effect is based on a combination of the pose of the hands of the user and the gaze of the user (as tracked by one or more eye-tracking cameras). In some examples, the haptic effect is based on a combination of the pose of the hands of the user and a determined location of the electronic pointing device within a virtual three-dimensional environment.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2A illustrates a block diagram of an example architecture for a device according to some examples of the disclosure.

FIG. 2B illustrates a block diagram of an example architecture for an electronic pointing device according to some examples.

FIGS. 3A-3K illustrate an example system and method for generating haptic effects on an electronic pointing device based on the pose of the hands of the user according to some examples of the disclosure.

FIG. 4 illustrates an example flow diagram illustrating a method of generating haptic effects on an electronic pointing device based on the pose of the hands of the user according to some examples of the disclosure.

### DETAILED DESCRIPTION

Some examples of the disclosure are directed to systems and methods for generating a haptic feedback response at an electronic pointing device based on the pose of one or more hands of the user. In one or more examples, an electronic device (e.g., computing system) has an electronic pointing device that is communicatively coupled (e.g., wired and/or wirelessly) to the electronic device and is configured to receive commands from the electronic to generate haptic feedback (e.g., vibration) patterns based on a detected pose of one or more hands of the user of the electronic pointing device.

In some examples, the pose of the hands of the user includes the location on the electronic pointing device where the hand is holding the pointing device. In some examples, the location of where the hand is holding the electronic pointing device is based on a sensor that is located on the electronic pointing device. Additionally or alternatively, the location is determined using one or more cameras associated with the electronic device that are configured to track the hands of the user. In some examples, the pose of the hands of the user includes an orientation of the hand when it is holding the electronic pointing device, which is optionally determined based on the one or more cameras associated with the electronic device that are configured to track the hands of the user. In some examples, the pose of the hand of the user includes the amount of force that the hand is applying to the electronic pointing device. Optionally, the force is determined using one or more force sensors that are located within the electronic pointing device. In some examples, the pose of the hands of the user includes a location and orientation of the hand of the user that is not holding the electronic pointing device.

In some examples, the haptic response generated by the electronic pointing device includes a stereo haptic effect that is generated on one or more ends of the electronic pointing device. In some examples, the stereo haptic is based on the location on the electronic pointing device where the hand is holding the device. In some examples, the stereo haptic effect includes a vibration pattern that is based on the pose of the hand. In some examples, the haptic effect is based on a combination of the pose of the hands of the user and the gaze of the user (as tracked by one or more eye-tracking cameras). In some examples, the haptic effect is based on a combination of the pose of the hands of the user and a determined location of the electronic pointing device within a virtual three-dimensional environment.

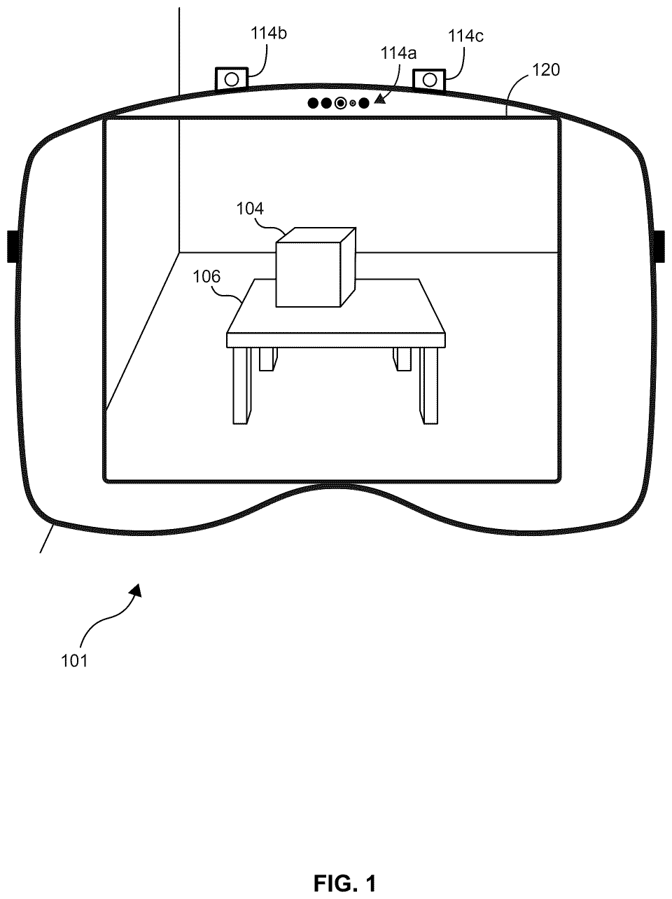

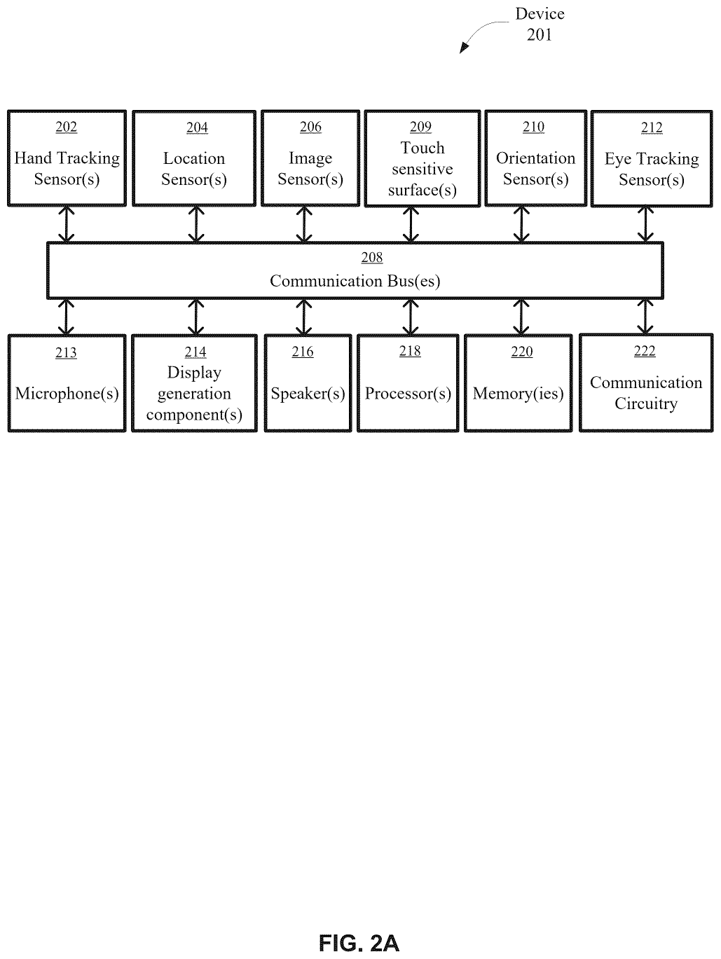

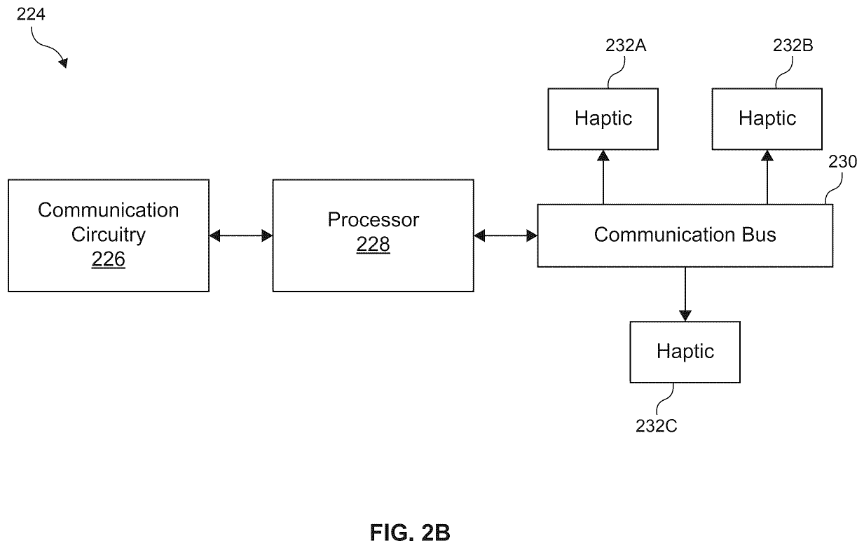

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Additionally or alternatively, electronic device 101 can be any computing system (such as a mobile phone) in which one or more cameras produce images of the environment of the user and can superimpose virtual objects onto a displayed environment. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2A). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device 101 may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

In some examples, the display 120 is provided as a passive component (e.g., rather than an active component) within electronic device 101. For example, the display 120 may be a transparent or translucent display, as mentioned above, and may not be configured to display virtual content (e.g., images of the physical environment captured by external image sensors 114b and 114c and/or virtual object 104). Alternatively, in some examples, the electronic device 101 does not include the display 120. In some such examples in which the display 120 is provided as a passive component or is not included in the electronic device 101, the electronic device 101 may still include sensors (e.g., internal image sensor 114a and/or external image sensors 114b and 114c) and/or other input devices, such as one or more of the components described below with reference to FIG. 2A.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the computer system as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the computer system. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the computer system optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described computer system, display and touch-sensitive surface are optionally distributed amongst two or more devices. Therefore, as used in this disclosure, information displayed on the computer system or by the computer system is optionally used to describe information outputted by the computer system for display on a separate display device (touch-sensitive or not). Similarly, as used in this disclosure, input received on the computer system (e.g., touch input received on a touch-sensitive surface of the computer system, or touch input received on the surface of a stylus) is optionally used to describe input received on a separate input device, from which the computer system receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2A illustrates a block diagram of an example architecture for a device 201 according to some examples of the disclosure. In some examples, device 201 includes one or more computer systems. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2A, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic device 201.

Communication circuitry 222 optionally includes circuitry for communicating with computer systems, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth® and can be used to establish a communications link between the device 201 and external components such as an electronic pointing device (described in further detail below).

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2A, but can include fewer, other, or additional components in multiple configurations. In some examples, electronic device 201 can be implemented between two computer systems (e.g., as a system). In some such examples, each of (or more) computer system may each include one or more of the same components discussed above, such as various sensors, one or more display generation components, one or more speakers, one or more processors, one or more memories, and/or communication circuitry. A person or persons using electronic device 201, is optionally referred to herein as a user or users of the system.

In one or more examples, and as described above, communication circuitry 222 of device 201 can be utilized to communicate with one or more external devices for the purpose of issuing commands to the device, and/or otherwise receiving and transmitting data/information from and to an external device. For instance, in one or more examples, and as described in detail below, device 201 can utilize communication circuitry 222 to communicate with an electronic pointing device. In some examples, an electronic pointing device is a device that can be used to interact with a three-dimensional environment as detailed below. In some examples, the electronic pointing device can include internal circuitry that enables the electronic pointing device to receive commands from electronic device and/or perform functionality associated with the electronic pointing device as illustrated in FIG. 2B.

FIG. 2B illustrates a block diagram of an example architecture for an electronic pointing device according to some examples. In some example, electronic pointing device 224 includes communication circuitry 226 that is configured to allow the electronic pointing device 224 to remain communicatively coupled with an electronic device such as electronic device 201 described with respect to FIG. 2A. In one or more examples, the communication circuitry 226 is communicatively coupled to processor 228 that is configured to receive communications from electronic device 201 and translate the communications to one or more commands that are used to operate the electronic pointing device 224 according to the commands provided by electronic device 201A.

In one or more examples, utilizing communication circuitry 226 in conjunction with processor 228, electronic pointing device 224 can receive and execute one or more commands from electronic device 201. For instance, electronic device 201 can provide a command to electronic pointing device 224 to generate a haptic feedback response using one or more haptic feedback engines 232a-232c. In some examples, haptic feedback engines 232a-232c are disposed at various locations within the electronic pointing device 224 and are configured to generate a haptic feedback response. In some examples, haptic feedback engines 232a-232c include one or more of a vibration component and/or an audio component that are configured to cause vibration and audio at the electronic pointing device 224 according to one more patterns and with a predefined magnitude.

Attention is now directed towards interactions with physical objects in the physical environment (e.g., presented in the three-dimensional environment). The interactions may also be applied to one or more virtual objects and/or visual representation of real-world objects that are displayed in a three-dimensional environment presented at a computer system (e.g., corresponding to electronic device 201).

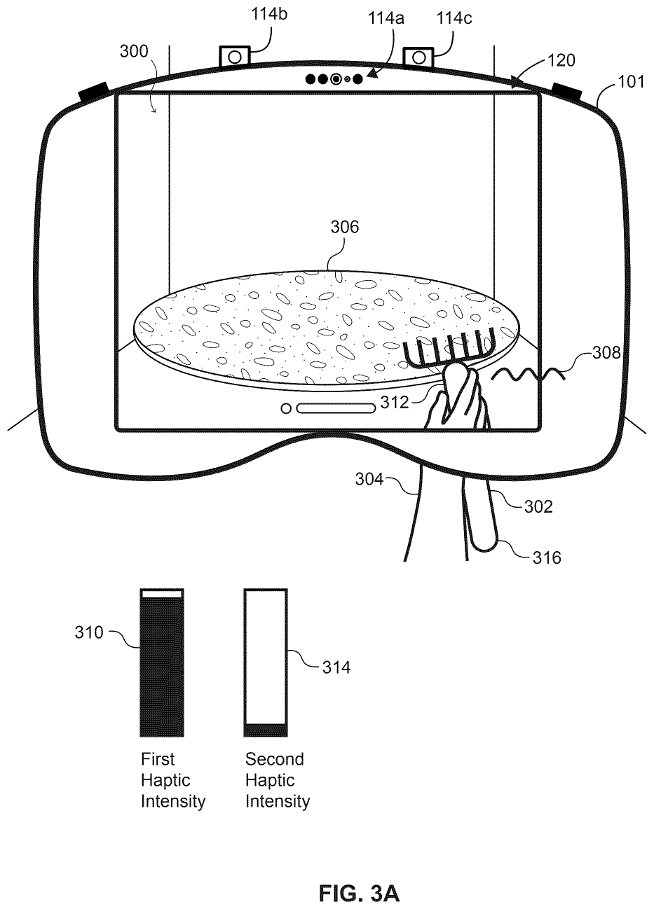

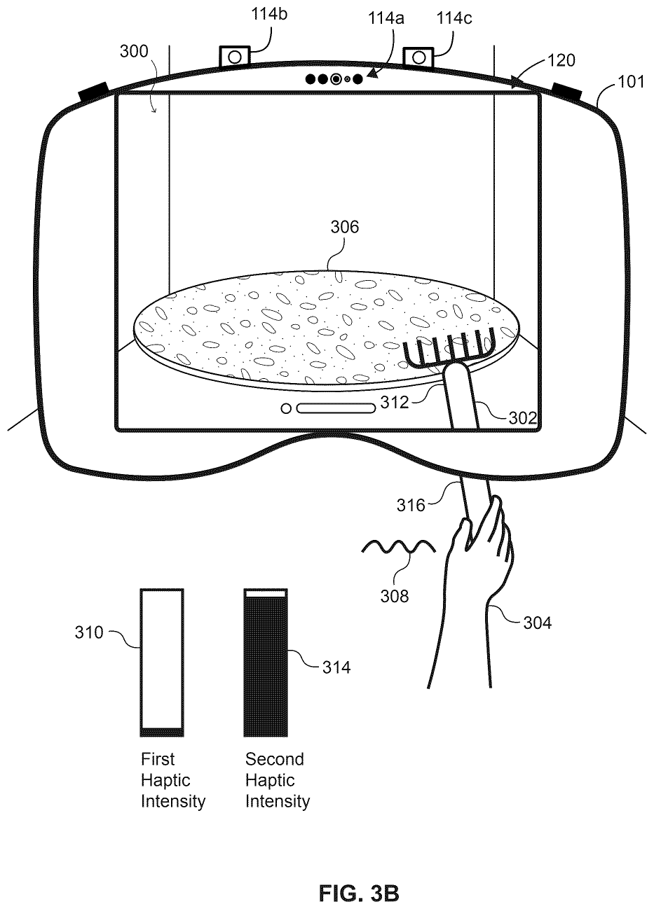

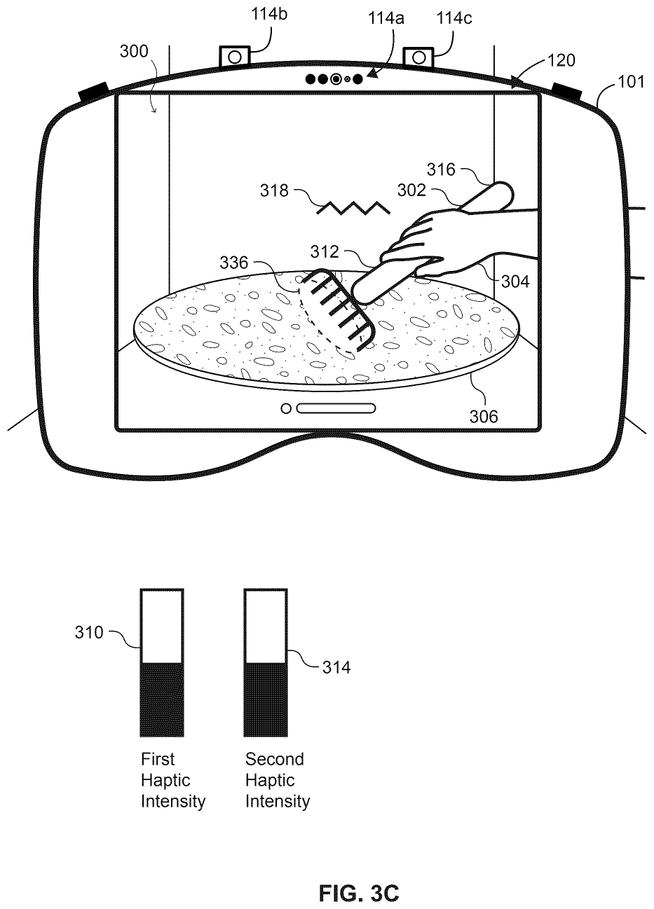

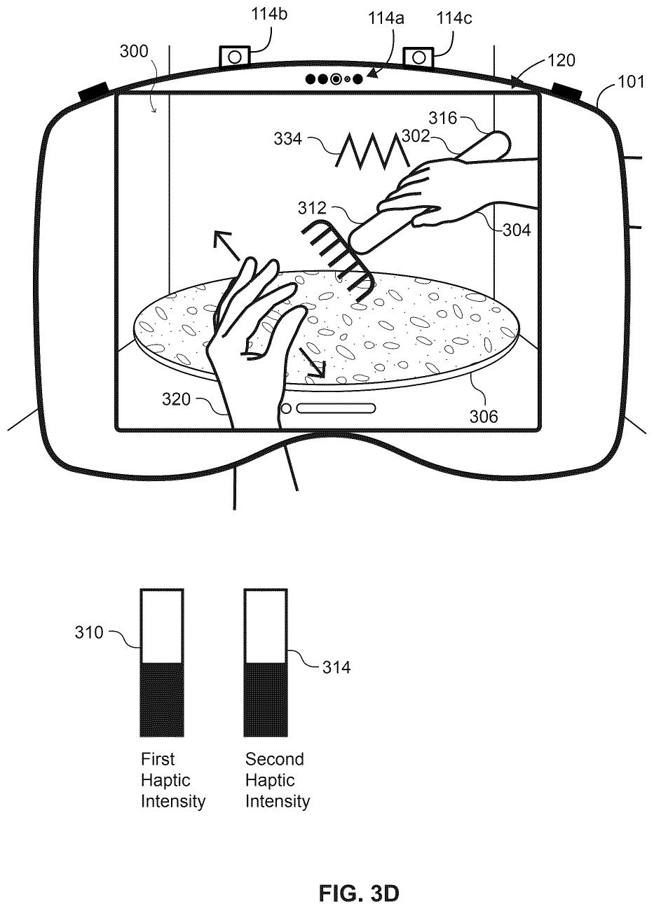

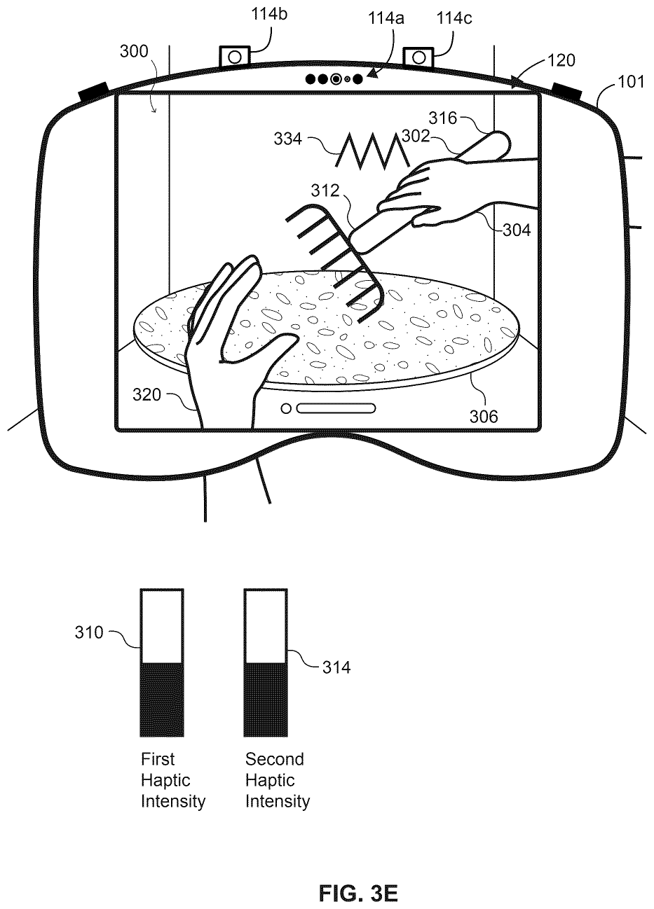

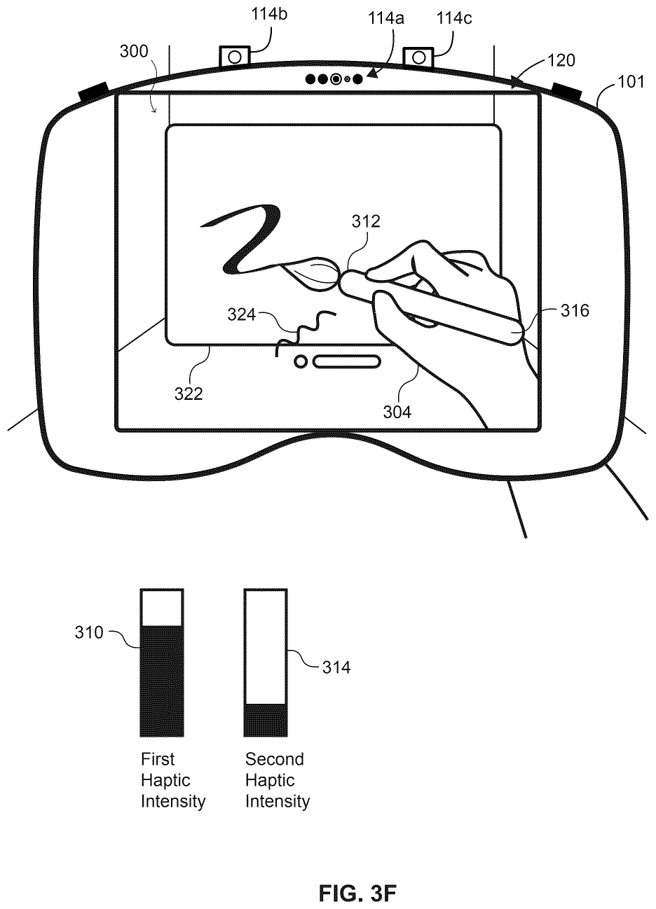

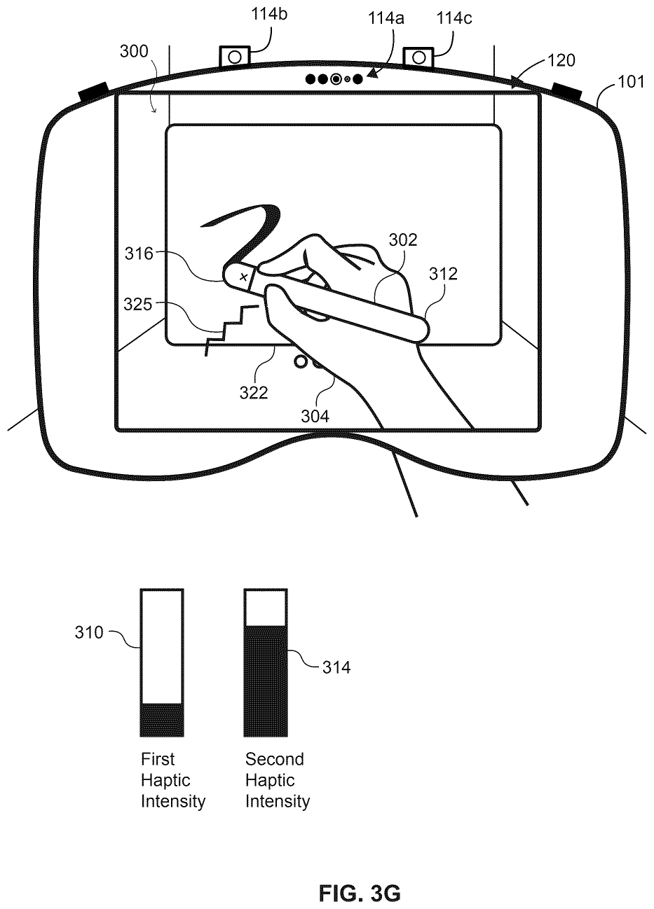

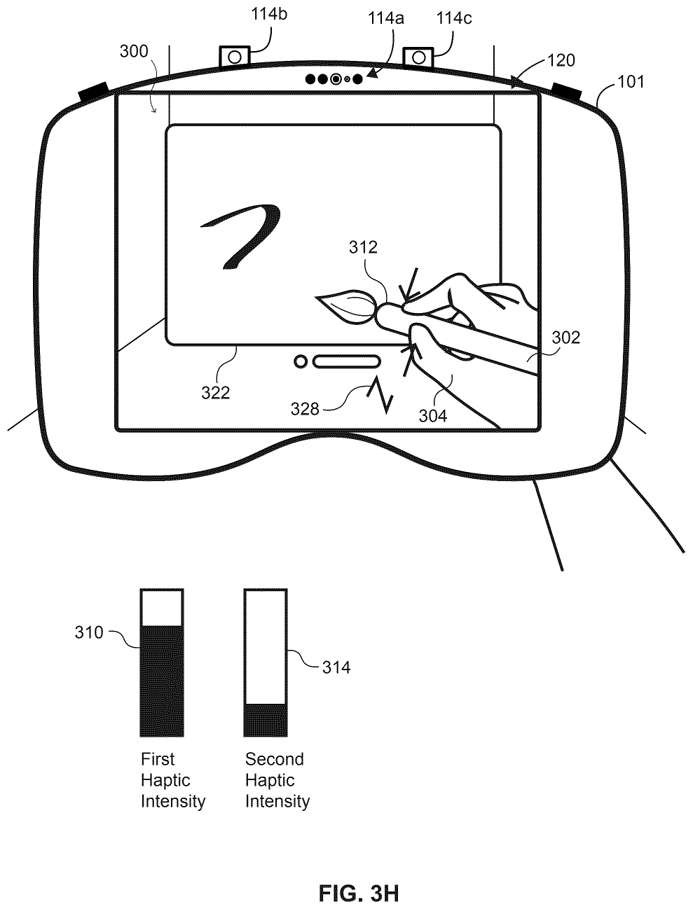

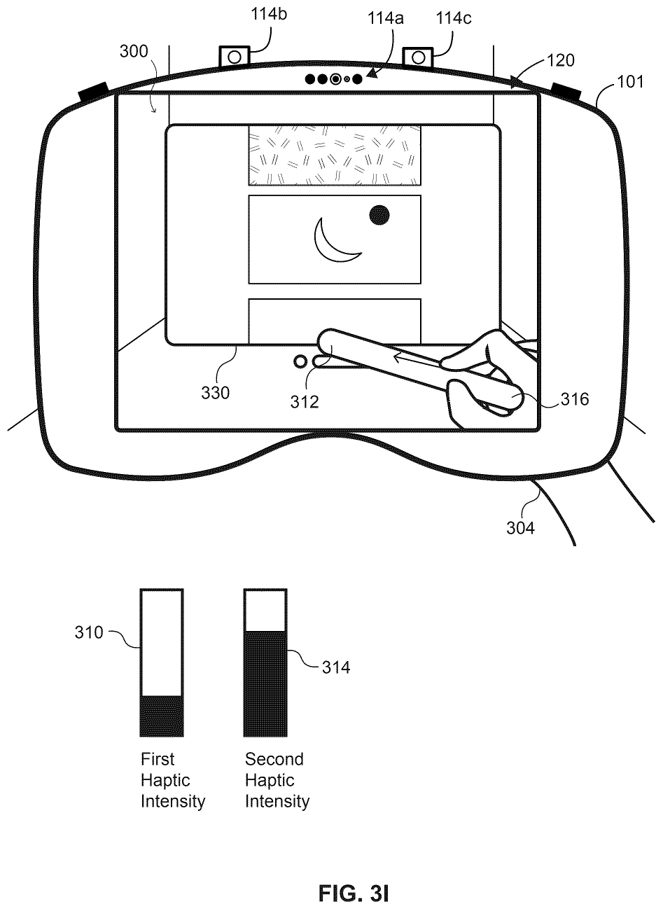

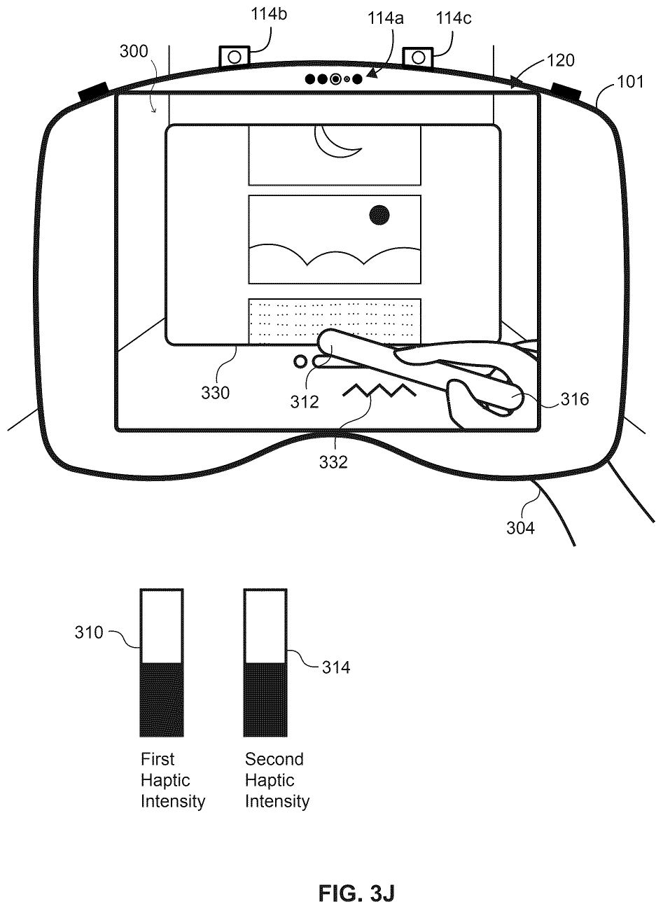

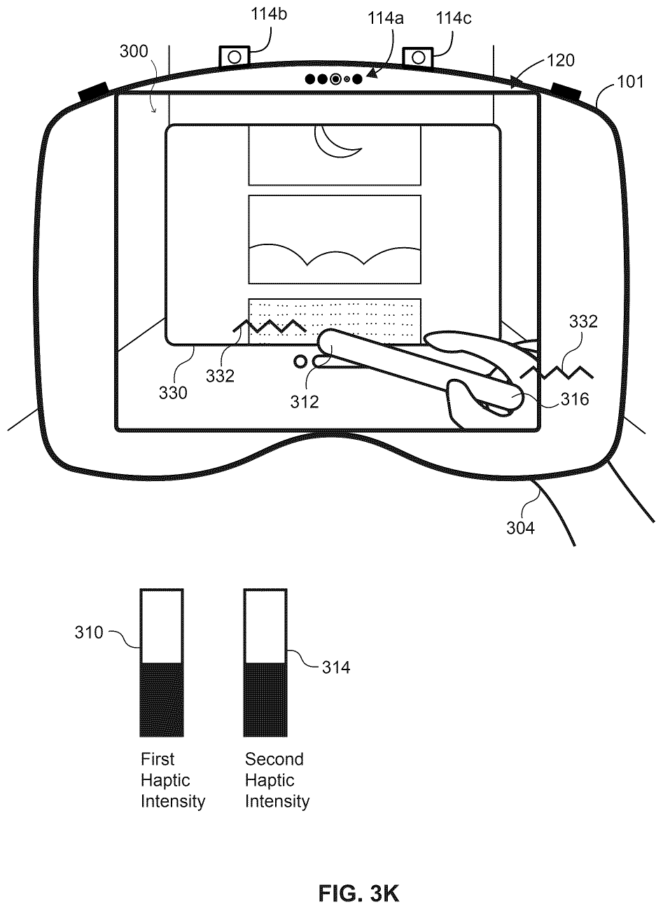

FIGS. 3A-3K illustrate examples of a haptics being generated on an electronic pointing device based on one or more detected poses of the hand of the user according to examples of the disclosure.

FIG. 3A illustrates an exemplary posed-based haptic response of an electronic pointing device according to examples of the disclosure. In one or more examples, the user of electronic device 101 utilizes an electronic pointing device 302 to interact with a virtual environment 300. In some examples, the electronic pointing device shares one or more characteristics of the electronic pointing device described below with respect to method 400. In some examples, the electronic pointing device 302 is configured to operate as an input device to electronic device 101. For instance, electronic device 101 is able to track (e.g., using one or more cameras, depth sensors, etc.) and monitor the position of electronic pointing device 302 within three-dimensional environment 300 that is being displayed by electronic device 101. In some examples, electronic pointing device 302 can include one or more sensors (e.g., rotation and/or orientation sensors) used to track its location within the three-dimensional environment 300 and send that information to electronic device 101. In some examples, the location of electronic pointing device can be tracked by electronic device 101, electronic pointing device 302, and/or a combination of both. In some examples, the electronic pointing device 302 is configurable (by the user and/or an application running on electronic device 101 that utilizes the electronic pointing device 302) to operate as one or more simulated tools so as to facilitate specific interactions with the three-dimensional environment. For instance, and as illustrated in FIG. 3A, the electronic pointing device 302 is configured to operate as a simulated “rake” in the context of interacting with a simulated sand garden 306 (e.g., a simulated surface of sand and/or rocks that the user is able to rake using the electronic pointing device 302). In some examples, operating the electronic pointing device 302 as a rake refers to operating the electronic pointing device 302 to include a virtual element that is configured to operate as a rake head and that is anchored to an end of the electronic pointing device 302, optionally including a virtual rake handle to match the rake head as a virtual overlay over the electronic pointing device 302. The example of the rake is meant as exemplary and should not be seen as limiting. In some examples, the electronic pointing device 302 can be operated as other tools such as (but not limited to) a shovel, a hoe, a knife, or other tool.

In one or more examples, the hand 304 of the user interacts with the electronic pointing device 302 to cause the electronic pointing device to interact with the three-dimensional environment 300. For instance, as illustrated in FIG. 3A, the hand 304 of the user holds the electronic pointing device in a particular pose so as to move the electronic pointing device across the simulated sand garden 306 (thereby simulating raking the sand garden). As described in further detail below, the pose of the hand refers to a set of characteristics including but not limited to the position of the fingers on the electronic pointing device, the grip of the hand on the electronic pointing device, and/or the force being applied to the electronic pointing device by hand 304. In some examples, the electronic pointing device 302 is configured to generate a haptic response in response to detected interactions between the electronic pointing device 302 and the three-dimensional environment, as well interactions between the electronic pointing device 302 and the hand 304 of the user that is controlling the electronic pointing device. For instance, in response to detecting the electronic pointing device 302 (with a virtual raking tool attachment as illustrated) raking the virtual sand garden 306, electronic device 101 generates a vibration pattern 308 at the electronic pointing device 302 that is configured to simulate the feeling of a rake going across a sand garden to the hand 304 of the user that is holding the electronic pointing device 302.

In some examples, the vibration pattern 308 is based on the location within the three-dimensional environment 300 that hand 304 is holding the electronic pointing device 302 and/or the interaction relative to the content that is within the three-dimensional environment. For instance, as illustrated in FIG. 3A, as hand 304 is holding the electronic pointing device 302 such that it is raking across the virtual sand garden 306, the electronic device generates the vibration pattern 308 in response to the detected location of electronic pointing device 302. In one or more examples, the electronic device 101 also generates the vibration pattern 308 in response to the orientation of hand 304 with respect to the electronic pointing device 302. For instance, as illustrated in FIG. 3A, in addition to generating a specific vibration pattern (such as vibration pattern 308), electronic device 101 also generates a stereo haptic effect within the electronic pointing device 302 to impart directionality to the haptic effect (e.g., cause the user to experience the vibration pattern 308 as if the vibration were emanating from a specific direction). In this way, by generating both a specific stereo haptic effect and imparting directionality to the haptic effect, the overall haptic effect more closely mimics the real-world counterpart haptics that would be felt in a real-world physical interaction.

In one or more examples, a stereo haptic effect refers to generating a haptic effect at a plurality of locations on the electronic pointing device, and modulating an intensity of the haptic effect generated at each location of the plurality of locations so as to create an effect that a single haptic effect is being generated at a specific location on the electronic pointing device (when in reality there are multiple haptic effects being generated at multiple locations on the electronic device). In one or more examples, modulating an intensity of the haptic effect includes but is not limited to: modulating the volume, bass, treble, tone, vibration intensity, vibration pattern, vibration frequency, and/or vibration duration so as to attain the desired stereo haptic effect. In the example of FIG. 3A, electronic pointing device generates vibration pattern 308 at two separate locations on the electronic pointing device (indicated as first end 312, and second end 316).

In one or more examples, the intensity at which the vibration pattern 308 is played at each end 312 and 316 (including optionally turning the pattern on and/or off at each end 312 and 316) is based on the orientation of the hand 304 of the user with respect to the electronic pointing device 302. For instance, in the example of FIG. 3A, since the hand 304 of the user is closer to end 312 of the electronic pointing device, the intensity 310 of the vibration pattern 308 generated at end 312 is significantly stronger than the intensity of the vibration pattern generated at end 316, thereby creating the effect that the user is holding the virtual rake closer to one end than the other. Thus, in one or more examples, the characteristics of the haptic feedback generated at electronic pointing device 302, is based on the location of the hand 304 within the three-dimensional environment as well as the orientation of the hand 304 with respect to the electronic pointing device 302. In some examples, the location of the hand 304 within the three-dimensional environment as well as the orientation of the hand 304 with respect to the electronic pointing device 302 are collectively referred to as the “pose” of the hand 304 with respect to the electronic pointing device 302. Thus, in some examples, the haptic feedback (e.g., the vibration pattern as well as how the vibration pattern is executed on the electronic pointing device) is based on the pose of the hand 304 of the user with respect to the electronic pointing device. In some examples, if the pose of hand 304 of the user changes with respect to the electronic pointing device 302, then the haptic feedback is also changed in one or more ways based on the new pose of the hand 304 of the user as illustrated in FIG. 3B.

In the example of FIG. 3B, the hand 304 of the user operates the electronic pointing device 302 at the same location within the three-dimensional environment 300 as in FIG. 3A (e.g., raking the sand garden 306) however, hand 304 is oriented differently in the example of FIG. 3B versus the example of FIG. 3A. In the example of FIG. 3B, hand 304 is positioned closer to end 316 (versus being positioned close to end 312 in FIG. 3A) while it is raking the virtual sand garden 306 with the electronic pointing device 302 (in the virtual rake configuration). Thus, in the example of FIG. 3B, while raking the sand garden 306 causes the same vibration pattern 308 to be generated as in FIG. 3A, the intensity of the haptic effect at ends 312 and 316 are modified in accordance with the position of hand (e.g., the pose of the hand) being closer to the other end 316 of the electronic pointing device. In the example of FIG. 3B the intensity 314 at end 316 is significantly higher than the intensity 310 at end 312, so that hand 304 receives a sensation from the haptic that replicates the feeling of using the rake by holding the far end of the rake when raking the sand garden. As demonstrated in the example of FIG. 3B, the electronic device 101 modifies or customizes the haptic effect (e.g., the vibration pattern and/or the stereo haptic effect) based on the pose of the hand of the user. In addition to the orientation of the hand with respect to the electronic pointing device, electronic device 101 also generates a customized haptic effect based on the location of the hand 304 with respect to the three-dimensional environment 300 (e.g., another component of the overall pose of the hand described herein as illustrated in the example of FIG. 3C, to further mimic real-world haptic effects for improved user experience.

In the example of FIG. 3C, as hand 304 guides the electronic pointing device 302 across the sand garden 306, the electronic device 101 determines that the hand 304 of the user has guided the virtual rake (e.g., the simulated tool that the electronic pointing device configured as) so as to strike a virtual rock 336 that is embedded within the virtual sand garden 306. In response to the determination that hand 304 has moved the electronic pointing device to the location of the virtual rock 336, the electronic device 101 causes the electronic pointing device 302 to generate a vibration pattern 318 that is meant to simulate the vibration that the hand of the user would feel if they were to strike a physical rock in a real-world physical sand garden with a real-world rake. In some examples, the vibration pattern 318 is different than the vibration pattern 308, with the difference owing to the fact that in the examples of FIGS. 3A and 3B, the virtual rake was moving across sand, and in the example of FIG. 3C, the virtual rake (in response to detected motion of hand 304) has struck a virtual rock and thus the difference between vibration pattern 318 and vibration pattern 308 accounts for the differences in material properties of sand and rock (e.g., mass, size, coarseness, etc.).

In some examples, the intensities 310 and 314 of the haptic effects generated at the first end 312 and the second end 316 are commensurate with the orientation of the hand 304 with respect to the electronic pointing device 302. For instance, since the hand is located at the middle of the electronic pointing device 302, the intensity 310 and intensity 314 can be the same so as to cause the haptic effect to be felt at the center of the electronic pointing device 302.

In some examples, in addition to the hand that is holding or otherwise physically interacting with the electronic pointing device, the haptic effect generated at the electronic pointing device can also be based on the pose of the non-holding hand of the user. For example, FIGS. 3D-3E illustrate adjusting a characteristic of the tool, and a corresponding haptic effect, using a non-holding hand for input. In the example of FIG. 3D, while hand 304 of the user is holding the electronic pointing device 302, the non-holding hand 320 performs a gesture (for instance by bringing the fingers of hand 320 together, such as to a multi-finger pinch, and expanding them away from each other) indicating a modification to the virtual rake that is being simulated by the electronic pointing device 302. In one or more examples, in response to detection of the gesture being performed by hand 320, and based on the orientation of hand 304 with respect to the electronic pointing device, electronic device 101 causes a haptic effect to be generated at the electronic pointing device 302 that includes a vibration pattern 334 being generated at both end 312 and end 316 at intensity 310 and 314. In some examples, the orientation, location, and/or pose of the non-holding hand 320 in combination with the orientation, location, and/or pose of hand 304 (the holding hand) collectively constitute the pose of the hands of the user that influence the haptic effect generated by the electronic device 101 at electronic pointing device 302. In one or more examples, as illustrated in FIG. 3E, in response to detecting the gesture being performed by the non-holding hand 320, the rake portion of the virtual rake enlarges while the haptic effect is concurrently being generated at the electronic pointing device 302. As illustrated in the example of FIG. 3E, the haptic effect is generated without any movement of the electronic pointing device 302. The haptic generated in the example of FIG. 3E provides for an improved user experience because the haptic allows the user to understand by touch that the rake is changing properties.

In one or more examples, the pose of the hand of the user and thus the haptic effect generated at the electronic pointing device 302 is based on the manner in which the hand 304 (e.g., the holding hand) is holding the electronic pointing device as illustrated in the examples of FIGS. 3F-3G. For instance, in the example of FIG. 3F, the electronic pointing device 302 is configured as a simulated paint brush. As illustrated in FIG. 3F, hand 304 holds the electronic pointing device 302 so that the brush end (e.g., end 312) is in proximity or touching canvas user interface 322. In some examples, in response to detecting that simulated brush is touching or in near proximity to canvas user interface 322, the electronic device 101 generates haptic feedback at the electronic device. For instance, the haptic feedback includes generating vibration pattern 324 according to an intensity 310 at end 312 and an intensity 314 and end 316. In some examples, the intensity 310 and intensity 314 are based on the position of hand 304 along the length of the electronic pointing device in accordance with the examples described above. In the example of FIG. 3F, because hand 304 is closer to end 312 than hand 304 is to end 316, the electronic device generates the haptic feedback such that intensity 310 is greater than intensity 314 in accordance with the position of the hand of the user with respect to the electronic pointing device 302.

In some examples, the electronic device 101 can detect that the hand of the user has changed the orientation of the electronic pointing device (e.g., by detecting movement of the hand that repositions the electronic pointing device) and in response generates a different haptic feedback such as illustrated in FIG. 3G. In the example of FIG. 3G, the hand 304 of the user is detected as turning the electronic pointing device 302 around, such that end 316 is at or near canvas user interface 322 (instead of end 312 as in the example of FIG. 3F). Additionally and/or alternatively, the electronic device 101 detects that electronic pointing device 302 is turned around by detecting the pose or orientation of the hand. In one or more examples, electronic device 101, in response to detecting the change in the orientation of hand 304 so as to re-orient the electronic pointing device, configures the electronic pointing device 302 to operate as a simulated eraser. Thus, in accordance with configuring the electronic pointing device 302 as an eraser, in response to detecting contact of the electronic pointing device 302 (and specifically end 316) with the canvas user interface 322, the electronic device 101 causes a different haptic feedback (when compared to the haptic feedback of FIG. 3F using for inking with the brush) to be generated at the electronic pointing device 302. Specifically, the electronic pointing device generates vibration pattern 324 with an intensity 310 at end 312, and intensity 314 at end 316 as illustrated in FIG. 3G. In one or more examples, the intensity 314 is higher than intensity 310 since the electronic device 101 detects that the hand 304 of the user is closer to end 316 than it is to end 312.

In one or more examples, the pose of the hand that haptic feedback is based on includes the amount of force that the hand is applying to the electronic pointing device as illustrated in FIG. 3H. As illustrated in FIG. 3H, hand 304 applies force (indicated by squeezing motion of the fingers of the hand 326) to the electronic pointing device. In one or more examples, the electronic device 101 detects the force being applied to the electronic pointing device, by tracking the movement of the hands using one or more outward facing cameras (114b-114c) to determine that hand 304 is moving consistent with applying force to the electronic device. In some examples, electronic device is able to estimate the force being applied to the electronic device by measuring the movement of the fingers of hand 304 in relation to the body of the electronic pointing device 302. Additionally or alternatively, electronic pointing device 302 includes one or more force sensors (e.g., capacitive, piezoelectric, strain gauges, etc.) that are configured to detect force being applied to the electronic pointing device 302 by a hand or other external element. In response to detecting the force being applied to the electronic pointing device through the one or more sensors, the data from the sensors is transmitted to the electronic device 101 for processing to determine the amount of force being applied to the electronic pointing device.

In one or more examples, and as illustrated in FIG. 3H, electronic device 101 causes a haptic feedback to be generated at the electronic pointing device 302 in accordance with the detected force that is being applied to the electronic pointing device 302. For instance, electronic device causes a vibration pattern 328 to be generated at end 312 with intensity 310 and at end 316 with intensity 314, thus providing a haptic feedback indicating that the hand of the user has squeezed the electronic pointing device 302 with enough force to perform an operation on the electronic device, or that the force applied has surpassed a predefined force threshold.

In some examples, the hand of the user holding the electronic pointing device 302 can cause a haptic feedback to be generated based on a gesture or predefined interaction performed on the electronic pointing device 302 as illustrated in FIGS. 3I-3K. In the example of FIGS. 3I-3K (and described in detail below) the hand 304 of the user performs a gesture on the electronic pointing device that causes an operation to be performed on the electronic device 101 and also causes a haptic feedback to be generated on the electronic pointing device 302.

FIG. 3I illustrates the user of electronic device 101 interacting with a content window 330, that includes scrollable content (e.g., content that be scrolled up and/or down). In one or more examples, electronic device 101 detects hand 304 initiating a gesture on electronic pointing device 302 by detecting that a respective finger (e.g., index finger) of hand 304 being placed relatively toward end 316 of the electronic pointing device 302 as illustrated in FIG. 3I. In one or more examples, electronic device 101 detects that a finger of the hand of the user moves along the length of the electronic pointing device 302 as illustrated in FIG. 3J. As illustrated in FIG. 3J, in response to detecting that the finger of hand 304 moves along the length of the electronic pointing device 302, electronic device 101 scrolls the scrollable content and causes a haptic feedback to be generated at the electronic pointing device 302 that includes a vibration pattern 332 being generated at ends 312 and 316 with intensity 310 and 314. In some examples, in order to facilitate detection of gestures performed on the electronic pointing device 302, the electronic pointing device can include one or more touch sensors (e.g., capacitive, resistive, etc.) to enable detecting touch inputs being applied to the electronic pointing device.

In one or more examples, and as illustrated in FIG. 3K, electronic device 101, in response to detecting that the finger of the hand 304 of the user continues movement across the electronic pointing device 302 and then lifts off of the electronic pointing device, continues scrolling the scrollable content of window 330, while continuing to generate the haptic feedback described above with respect to FIG. 3J. As illustrated in the example of FIGS. 3I-3K, the pose of the hand of the user that the haptic feedback is based on includes determining whether the hand is performing a predefined gesture at the electronic pointing device. In one or more examples, the haptic that is generated can be based on the movement of the user interface elements. For instance, in the example of FIG. 3K, the vibration pattern 332 can be associated with movement of elements within content window 330 that are moving due to the gestures being performed by hand 304.

In some examples, the haptic intensities and waveforms described above can be triggered by various operations performed by the computing device in response to detected movement and/or operations performed using the electronic pointing device. For instance, in one or more examples, a particular haptic effect can be generated when a user is applying a force to the electronic pointing device (such as in the example of FIG. 3H), and a haptic effect can additionally be generated when the electronic device determines that the user releases the force (e.g., removes the force that is being applied to the electronic pointing device). In some examples, a particular haptic effect or waveform can be triggered in response to detecting that the electronic pointing device and a virtual object being presented in a three-dimensional environment are in spatial conflict with one another (e.g., the electronic pointing device collides with a virtual object in the three-dimensional environment). Additionally and/or alternatively, a particular haptic effect can be triggered at the electronic pointing device when the electronic device determines that two separate virtual objects collide with one another in the three-dimensional environment (e.g., become spatially conflicted) due to moving one of the virtual objects using the electronic pointing device. In some examples, the haptic effect that is generated can be based on a material characteristic of the virtual object (e.g., objects that are softer will cause a “softer” haptic effect than objects that are harder).

In some examples, a particular haptic effect can be triggered based on a state of an operation being performed using the electronic pointing device. For instance, a particular haptic effect can be triggered when the electronic pointing device is traversing (e.g., moving) from one virtual object in the three-dimensional environment to a different virtual object in the three-dimensional environment. In some examples, a particular haptic effect can be triggered based on whether the electronic pointing device is being used to place a virtual object at a particular location within a three-dimensional environment. In some examples, in an example where the electronic device is being used to interact with multiple virtual objects in a three-dimensional environment, a particular haptic effect can be triggered upon detecting that there is a change in the virtual object that is being targeted for interaction with the electronic pointing device (e.g., because a gaze of the user is detected as moving from a first virtual object to a second virtual object thereby triggering a haptic effect).

In some examples, a particular haptic effect (e.g., a particular waveform and/or intensity of haptic effect) can be triggered periodically when the electronic device detects that the electronic pointing device is being used to measure a distance between two points. Additionally or alternatively, the haptic effect can be triggered based on a distance of movement (e.g., the haptic is triggered based on the distance traversed such that the haptic is triggered every time the electronic pointing device crosses a threshold distance such as every 1, 5, 10, 50, 100 cm) when a measurement is being taken with the electronic pointing device. In some examples, a particular haptic effect can be triggered when the electronic device detects that the electronic device is moving over a rotational distance (e.g., over a particular range of angles). In some examples, the various events/states of operation that trigger a particular haptic effect may or may not be based on the pose/orientation of a hand of the user with respect to the electronic pointing device. In some examples, the haptic effects described above may or may not be modified based on a determined pose of the hand of the user with respect to the electronic pointing device.

In some examples, the haptic effects described above that are triggered in response to an electronic device detecting that an electronic pointing device is being used to perform various operations and/or based on poses of a hand of the user with respect to the electronic pointing device facilitate efficient user interaction with the electronic device and the electronic pointing device by minimizing erroneous user inputs and thereby preserving computing resources associated that would otherwise be required to correct erroneous input.

In some examples, at an electronic device in communication with one or more displays and one or more input devices, wherein the one or more input devices include an electronic pointing device, while a user of the electronic device is interacting with a three-dimensional environment using the electronic pointing device, the electronic device receives an indication of an operation being performed by the electronic pointing device. In some examples, in response to receiving the indication of operation being performed by the electronic pointing device, in accordance with a determination that the operation is a first operation, the electronic device generates a first haptic feedback at the electronic pointing device. In some examples, in response to receiving the indication of operation being performed by the electronic pointing device, in accordance with a determination that the operation is a second operation, different from the first operation, the electronic device generates a second haptic feedback, different from the first haptic feedback, at the electronic pointing device.

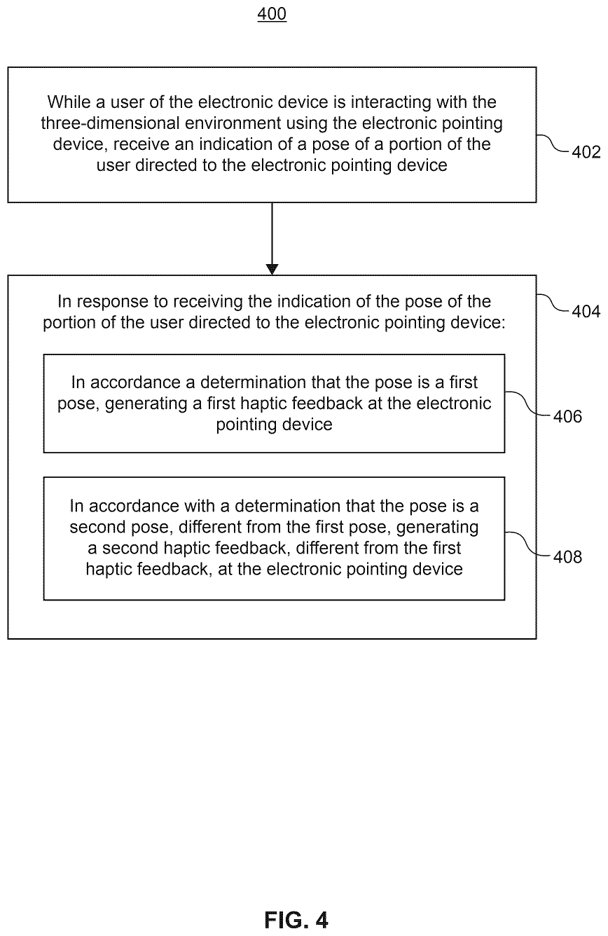

FIG. 4 illustrates an example flow diagram illustrating a method of generating haptic effects on an electronic pointing device based on the pose of the hands of the user according to some examples of the disclosure. In one or more examples, method (400) is performed at an electronic device in communication with one or more displays and one or more input devices, wherein the one or more input devices include an electronic pointing device. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In one or more examples, the display generation component is a display integrated with the electronic device (optionally a touch screen display), external display such as a monitor, projector, television, or a hardware component (optionally integrated or external) for projecting a user interface or causing a user interface to be visible to one or more users, etc. In one or more examples, the electronic device is part of an electronic device that is part of a wearable device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller. In one or more examples, the electronic pointing device is communicatively coupled to the electronic device, either via a wired or wireless communication link, and is configured to provide inputs to the electronic device. For instance, the electronic pointing device includes one or more components that are configured to allow for the electronic device to determine a pose of the electronic pointing device with respect to electronic device, screen, and/or displayed user interface. Thus, in one or more examples, the electronic device is able to determine the position and/or the orientation of the electronic pointing device with respect to the electronic device. In one or more examples, the electronic device obtains pose information including position/attitude (pitch, yaw, and/or roll), orientation, tilt, path, force, distance, and/or location of the input device relative to the electronic device, screen, and/or displayed user interface from one or more sensors of the input device, one or more electrodes in a touch-sensitive surface, and/or other input devices.

In some examples, while a user of the electronic device is interacting with the three-dimensional environment using the electronic pointing device, the electronic device receives an indication of a pose of a portion of the user directed to the electronic pointing device. In one or more examples, the three-dimensional environment is an extended reality (XR) environment, such as a virtual reality (VR) environment, a mixed reality (MR) environment, or an augmented reality (AR) environment. In one or more examples, the pose of the portion of the user directed to the electronic pointing device refers to a set of characteristics pertaining to the way in which a user of the electronic device is interacting with the electronic pointing device. For instance, the pose refers to, but is not limited to: the location on the electronic pointing device that user is holding or touching the electronic pointing at, the force that the user is applying to the electronic pointing device, the orientation of the hand of the user when interacting with the electronic pointing device, and/or the orientation of the a hand of the user that is not holding the electronic pointing device. In one or more examples, the pose of the portion of the user directed to the electronic pointing device can be determined based on data taken from one or more input devices associated with the electronic device and/or the electronic pointing device including but not limited to: one or more sensors located on the electronic pointing device, image sensors/cameras, depth sensors, and/or touch sensors. Thus, in one or more examples, receiving an indication of the pose of the portion of the user directed to the electronic device includes receiving data at the electronic device from one or more of the input devices/sensors that are part of and/or communicatively coupled to the electronic device.

In some examples, in response to receiving the indication of the pose of the portion of the user directed to the electronic pointing device: in accordance a determination that the pose is a first pose, the electronic device generates a first haptic feedback at the electronic pointing device. In some examples, in accordance with a determination that the pose is a second pose, different from the first pose, the electronic device generates a second haptic feedback, different from the first haptic feedback, at the electronic pointing device. In one or more examples, the electronic device using the various input devices used to monitor the pose of the portion of the user (e.g., the hand of the user) as described above, and determines the pose of the portion of the user with respect to the electronic pointing device. In one or more examples, the electronic device after determining the pose of the portion of the user with respect to the electronic device, determines if the pose matches one or more pre-defined poses (e.g., the first pose and/or the second pose) that are stored on the electronic device. In some examples, the first pose and the second pose refer to a distinct set of characteristics such as orientation of the portion of the user, force, location on the electronic pointing device that the hand is touching, etc. In one or more examples, if the determined pose of the portion of the user substantially (e.g., exactly) matches a pre-defined pose stored in the memory of the electronic device, the electronic device generates a pre-defined haptic feedback that is associated with the pre-defined pose. For instance, in the event that the electronic device determines that the pose of the portion of the user matches the first pose, the electronic device generates a first haptic feedback that is associated with the first pose. In one or more examples, The “haptic feedback” refers to physical displacement of the electronic pointing device relative to a previous position of the electronic pointing device, physical displacement of a component (e.g., a touch-sensitive surface) of the electronic pointing device relative to another component (e.g., housing) of the electronic pointing device, or displacement of the component relative to a center of mass of the electronic pointing device that will be detected by a user with the user's sense of touch. A cycle of displacement or oscillation is thus a single displacement of the component away from and back to an original position. In one or more examples, the haptic feedback includes optionally a vibration of a component of the electronic pointing device, e.g., a rhythmic or cyclical physical displacement of the component of the electronic pointing device or the vibrating component that will be detected by the user with the user's sense of touch. A vibration has a variety of characteristics. In one or more examples, a vibration optionally has a quantity of cycles, a duration, a frequency, and an intensity. Further, in one or more examples, a frequency and intensity of a vibration optionally varies with the duration of vibration, forming a frequency profile and an intensity profile, respectively. In one or more examples, a vibration comprises a single cycle of displacement or a single oscillation. In one or more examples, a vibration includes two or more oscillations. In one or more examples, a vibration includes two or more vibrations separated by one of more time intervals. A vibration is optionally thus also characterized by a vibration pattern, which is formed by a combination the duration, frequency profile, and intensity profile of a vibration, In one or more examples. Each characteristic of a haptic feedback that is detectable by the user and can be interpretated by the user as a tactile sensation constitutes an output characteristic of the haptic feedback, In one or more examples. In one or more examples, output characteristics of the one or more haptic feedback optionally include the perceived intensity, pattern, or duration of the physical displacement of the electronic pointing device or a component thereof. Output characteristics of the haptic feedbacks optionally further include a duration, frequency, frequency profile, intensity, intensity profile, or pattern of a vibration that a haptic feedback comprises, In one or more examples. Output characteristics optionally further include the user's overall sensory perception of the haptic feedback. In one or more examples, the electronic device optionally causes a haptic feedback to be generated at the electronic pointing device (e.g., by transmitting a signal to the electronic pointing device that causes the electronic pointing device to generate the haptic feedback). In one or more examples, the haptic feedback is optionally localized in that the vibration is generated a particular surface of the electronic pointing device. Optionally or alternatively, the vibration is generated at the touch-sensitive or force-sensitive surface or predetermined surface whose depression by the user generates a squeeze input. In one or more examples, the haptic feedback is optionally localized outside of that surface on the electronic pointing device. In one or more examples, the haptic feedback is optionally generated on the whole electronic pointing device or can be felt by the user on any surface of the electronic pointing device. The haptic feedbacks are optionally generated at the electronic pointing device to communicate with or alert the user to a change of the state in the electronic device or the user interface. In one or more examples, the haptic feedbacks are optionally generated at the electronic pointing device in response to an electronic pointing device input. In one or more examples, the electronic device optionally causes a haptic feedback to be generated at the electronic pointing device in response to various interactions between the electronic pointing device and the electronic device (described in further detail below) thus providing the user with a feedback mechanism for interacting a three-dimensional environment.

In some examples, the received indication of the pose of the portion of the user includes an indication of a location on the electronic pointing device where the portion of the user is interacting with the electronic pointing device. In one or more examples, the information about the pose of the portion of the user received at the electronic device is received from the electronic pointing device and/or one or more sensors that are communicatively coupled to the electronic device. In one or more examples, the location on the electronic pointing device where the portion of the user interacting with the electronic device refers to a portion or area of the electronic pointing device that is being touched by the portion of the user. For instance, in the example where the portion of the user is a hand of the user, the location would include the portion of the electronic pointing device where the hand is either touching and/or holding the electronic pointing device. In some examples, the indication of the location on the electronic pointing device where the portion of the user is interacting with the electronic pointing device includes detecting the specific location on the electronic pointing device where of one or more specific fingers of the hand of the user. In some examples, and in the example where the electronic pointing device includes a shaft portion, the location where the user is interacting with the electronic pointing device refers to the location along the shaft of the pointing device where the hand of the user is holding or touching the shaft (e.g., handle) of the electronic pointing device.

In some examples, the indication of a location on the electronic pointing device where the portion of the user is interacting with the electronic device is received from one or more sensors that are part of the electronic pointing device. In one or more examples, the indication of the location on the electronic pointing device where the portion of the user is interacting with the electronic pointing device is received from one or more touch sensors that are disposed on or within the electronic pointing device. For instance, the electronic pointing device can include one or more capacitive touch sensors, force sensors, resistive sensors, surface acoustic wave sensors, and/or other touch sensor that is configured to and arranged to transmit the precise location on the electronic pointing device that is being touched/held by the user of the computing device.

In some examples, the one or more input devices include one or more cameras, and wherein the indication of a location on the electronic pointing device where the portion of the user is interacting with the electronic pointing device is received from the one or more cameras. In one or more examples, the indication of the location on the electronic pointing device where the portion of the user (e.g., hands) of the user is interacting with the electronic pointing device is received from one or more cameras/image sensors that are part of and/or communicatively coupled to the electronic device. In one or more examples, the cameras/image sensors are positioned on the head mounted display (described above) or are otherwise positioned to view the electronic pointing device when the electronic pointing device is interacting with the three-dimensional environment. In one or more examples, the cameras/image sensors send image data to the electronic device, and the electronic device determines if the received image data includes images of the electronic device and the portion of the user interacting such that the electronic device can determine the approximate location on the electronic pointing device where the user is interacting with the electronic pointing device.

In some examples, the received indication of the pose of the portion of the user includes an indication of an orientation of the portion of the user with respect to the electronic pointing device. In one or more examples, the orientation of the portion of the user with respect to the electronic pointing device refers to the relative position of portion of the user (e.g., hand) relative to the electronic pointing device. For example, in the case of the user's hand, the orientation can include but is not limited to, the position of each finger of the user's hand with respect to the electronic pointing device, the position of the user's palm with respect to the electronic pointing device, and/or the location of the knuckles of the user with respect to the electronic pointing device. In one or more examples, the orientation of the portion of the user with respect to the electronic pointing device is determined by the electronic device based on data received from one or more sensors that are part of and/or communicatively coupled to the electronic device (described in further detail below).

In some examples, the one or more input devices include one or more eye tracking cameras, and wherein the indication of the orientation of the portion of the user with respect to the electronic pointing device is received from the one or more eye tracking cameras. In one or more examples, the orientation of the portion of the user (e.g., hands) of the user is with respect to the electronic pointing device is received from one or more cameras/image sensors that are part of and/or communicatively coupled to the electronic device. In one or more examples, the cameras/image sensors are positioned on the head mounted display (described above) or are otherwise positioned to view the electronic pointing device when the electronic pointing device is interacting with the three-dimensional environment. In one or more examples, the cameras/image sensors send image data to the electronic device, and the electronic device determines if the received image data includes images of the electronic device and the portion of the user interacting such that the electronic device can determine the orientation of the user's hand with respect to the electronic pointing device when the user is interacting with the electronic pointing device.

In some examples, the received indication of the pose of the portion of the user includes an indication of a force being applied to the electronic pointing device by the portion of the user. In one or more examples, the pose of the portion of the user includes a combination of orientation of the hand with respect to the electronic pointing device as well as the force being applied by the portion of the user to the electronic device (amongst other characteristics). In one or more examples, the force being applied to the electronic pointing device by the portion of the user (e.g., the user's hands) is measured using one or more force sensors that are disposed on and/or disposed within the electronic pointing device. In one or more examples, the “force” that is measured includes the force of a squeeze being applied to the electronic pointing device and/or the amount of force being used to push a surface of the electronic pointing device.

In some examples, the received indication of the pose of the portion of the user includes an indication of a pose of a hand of the user that is holding the electronic pointing device, and an indication of a pose of a second hand of the user that is not holding the electronic pointing device. In one or more examples, the pose in addition to the including aspects pertaining to the hand that is interacting with the electronic pointing device, also includes the orientation of hand of the user that is not interacting with (e.g., holding) the electronic pointing device. For instance, and as described above, in response to detecting that the user is modifying a simulated tool associated with the electronic pointing device using the non-holding (e.g., second hand) hand, the electronic device causes a haptic response to be generated at the electronic pointing device that corresponds to the modification to the simulated tool being applied by the second hand of the user. In one or more examples, the orientation of the non-holding hand is determined based on image sensor/camera data that is generated from one or more cameras/images sensors that are part of and/or communicatively couple do the electronic device (similar to the image sensors/cameras described above).

In some examples, one or more of the first haptic feedback and the second haptic feedback include a stereo haptic effect generated at the electronic pointing device, and wherein the stereo haptic effect is generated at one or more of a first end and a second end of the electronic pointing device. In one or more examples, a stereo haptic effect refers to generating a haptic effect at a plurality of locations on the electronic pointing device, and modulating an intensity of the haptic effect generated at each location of the plurality of locations so as to create an effect that a single haptic effect is being generated at a specific location on the electronic pointing device (when in reality there are multiple haptic effects being generated at multiple locations on the electronic device). In one or more examples, modulating an intensity of the haptic effect includes but is not limited to: modulating the volume, bass, treble, tone, vibration intensity, vibration pattern, vibration frequency, and/or vibration duration so as to attain the desired stereo haptic effect. In one or more examples, the plurality of locations at which a haptic effect is generated includes a first end of the electronic pointing device and a second end of the electronic device. In an example, where the electronic pointing device is cylindrical, the first end and the second end are disposed at opposite ends of the electronic pointing device. In some examples, the stereo haptic effect is generated in the above example, by modulating the intensity of the haptic feedback response.

In some examples, the stereo haptic effect comprises generating a haptic effect at both the first end and the second end of the electronic pointing device in response to the pose of the portion of the user. In one or more examples, the haptic effect at both the first end and the second end is the same (e.g., no matter the position of the hand (e.g., the holding hand) with respect to the electronic pointing device). For example, when generating the stereo haptic effect, the intensity, vibration pattern, and/or other haptic qualities are the same on both ends of the electronic pointing device, regardless of the pose of the hand of the user with respect to the electronic pointing device.

In some examples, the stereo haptic effect includes generating a first haptic effect at the first end, and generating a second haptic effect at the second end of the electronic pointing device, wherein generating the stereo haptic effect comprises: in accordance a determination that the pose is a third pose: the electronic device generates the first haptic effect at the first end of the electronic pointing device with a first weighting factor. In some examples, the electronic device generates the second haptic effect at the second end of the electronic pointing device with second weighting factor. In some examples, in accordance with a determination that the pose is a fourth pose, different from the third pose, the electronic device generates the first haptic effect at the first end of the electronic pointing device with a third weighting factor, different from the first weighting factor. In some examples, the electronic device generates the second haptic effect at the second end of the electronic pointing device with a fourth weighting factor, different from the second weighting factor. In one or more examples, the first weighting factor and the second weighting factor refer to an intensity of the haptic effect that is generated at the respective ends of the electronic pointing device. For instance, if the first weighting factor is greater than the second weighting factor, then the intensity of a vibration generated at the first end of the electronic pointing device is greater than the intensity of the vibration generated at the second end of the electronic pointing device. In one or more examples are based on the pose of the portion of the user (e.g., the location of the hand of the user) with respect to the electronic pointing device. For instance, if the hand of the user is grasping the electronic pointing device at a location on the electronic pointing device that is closer to the first end than the second end, then the first weighting factor can be higher than the second weighting factor such that the intensity of the vibration is higher on the first end than it is on the second end thus imparting a directionality to the overall haptic effect of the electronic pointing device (e.g., the haptic feels like it is emanating from the location where the user's hand is grasping the electronic pointing device). In one or more examples, in response to detecting that the hand of the user has moved to a different location on the electronic pointing device (e.g., the pose has changed from the third pose to the fourth pose) the electronic device causes the electronic pointing device to modify the first weighting factor and the second weighting factor to be commensurate with the changed location of the hand of the user relative to the electronic pointing device.

In some examples, the first haptic feedback includes a first vibration pattern, and where the second haptic feedback includes a second vibration pattern, different from the first vibration pattern. In one or more examples, the haptic feedback (including when part of a stereo haptic effect) includes generating a particular vibration pattern at one or both ends of the electronic pointing device. The vibration pattern can include modulating the length and duration of a vibration (e.g., intermittent short bursts of vibration intermixed with longer duration bursts of vibration). Additionally and/or alternatively, the vibration pattern can also include modulating the intensity of the vibration such that in a single period of the pattern the intensity of the vibration changes one or more times and then the same pattern of intensity repeats in the next period of the pattern. In one or more examples, the pattern is dependent on the pose of the portion of the user (e.g., the hand of the user) with respect to the electronic pointing device. For instance, if the pose is a first pose then the electronic device generates a first vibration pattern, and if the pose is a second pose, different from the first pose, the electronic device generates a second vibration pattern at the electronic pointing device that is different from the first vibration pattern (for instance if the user's hand is moving to close to the edge of the electronic pointing device, the electronic device will cause the electronic pointing device to generate a specific vibration pattern (e.g., unique pattern) that is configured to signal to the user that the position of the user's hand is getting close to the edge.

In some examples, in accordance with a determination that the pose satisfies one or more criteria, including a criterion that the pose is a third pose, and including a criterion that a gaze of the user is at a first location in the three-dimensional environment, the electronic device generates a third haptic feedback at the electronic pointing device. In some examples, in accordance with a determination that the pose satisfies one or more criteria, including a criterion that the pose is the third pose, and including a criterion that the gaze of the user is at a second location, different from the first location, in the three-dimensional environment, the electronic device generates a fourth haptic feedback at the electronic pointing device, different from the third haptic feedback. In one or more examples, the haptic feedback in addition to being based on the pose of the hand of the user (e.g., the portion of the user) is also based on the gaze of the user. For instance if the gaze of the user (e.g., the location in a three-dimensional environment that the user is looking as determined using data from one or more eye-tracking sensors of the electronic device) is looking a first virtual object, then the electronic device generates a haptic feedback at the electronic pointing device that is based not only on the pose of the user's hand but also on the virtual object that the user's gaze is directed to. Thus, in some examples, the electronic device can cause the electronic pointing device to generate two separate and distinct haptic effects depending on whether the user is gazing at a first virtual object versus a second virtual object even though the hand of the user is in the same pose with respect to the electronic pointing device. As an example, if the user is gazing at a virtual object that is soft in nature and is “slicing through the object” using the electronic pointing device, the electronic device causes the electronic pointing device to generate a first haptic feedback that is commensurate with cutting through a soft object. In the case where the virtual object is hard in nature, the electronic device causes the electronic pointing device to generate a haptic feedback that is commensurate with cutting through a hard object, even though the hand of the user is in the same pose with respect to the electronic pointing device.

In some examples, in accordance with a determination that the pose satisfies one or more criteria, including a criterion that the pose is a third pose, and including a criterion that a location of the electronic pointing device is at a first location in the three-dimensional environment, the electronic device generates a third haptic feedback at the electronic pointing device. In some examples, in accordance with a determination that the pose satisfies one or more criteria, including a criterion that the pose is the third pose, and including a criterion that the location of the electronic pointing device is at a second location, different from the first location, in the three-dimensional environment, generating a fourth haptic feedback at the electronic device, different from the third haptic feedback. In one or more examples, the haptic feedback is dependent on both the pose of the portion of the user with respect to the electronic pointing device as well as the location within the three-dimensional environment that the electronic pointing device is located. For instance, if a user is holding the electronic pointing device and cutting through an object that is located in front of the viewpoint of the user, a first haptic feedback is generated. If the user instead is holding the electronic pointing device in the exact same way as the cutting example above, but the electronic pointing device is directed at the floor of the three-dimensional environment, then a different haptic feedback is generated even though the pose of the hand of the user is the same.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays and one or more input devices, wherein the one or more input devices include an electronic pointing device:
while a user of the electronic device is interacting with a three-dimensional environment using the electronic pointing device, receiving an indication of a pose of a portion of the user directed to the electronic pointing device;
in response to receiving the indication of the pose of the portion of the user directed to the electronic pointing device:
in accordance a determination that the pose is a first pose, generating a first haptic feedback at the electronic pointing device; and
in accordance with a determination that the pose is a second pose, different from the first pose, generating a second haptic feedback, different from the first haptic feedback, at the electronic pointing device.

2. The method of claim 1, wherein the received indication of the pose of the portion of the user includes an indication of a location on the electronic pointing device where the portion of the user is interacting with the electronic pointing device.

3. The method of claim 1, wherein the received indication of the pose of the portion of the user includes an indication of an orientation of the portion of the user with respect to the electronic pointing device.

4. The method of claim 1, wherein the received indication of the pose of the portion of the user includes an indication of a force being applied to the electronic pointing device by the portion of the user.

5. The method of claim 1, wherein the received indication of the pose of the portion of the user includes an indication of a pose of a hand of the user that is holding the electronic pointing device, and an indication of a pose of a second hand of the user that is not holding the electronic pointing device.

6. The method of claim 1, wherein one or more of the first haptic feedback and the second haptic feedback include a stereo haptic effect generated at the electronic pointing device, and wherein the stereo haptic effect is generated at one or more of a first end and a second end of the electronic pointing device.

7. The method of claim 6, wherein the stereo haptic effect includes generating a first haptic effect at the first end, and generating a second haptic effect at the second end of the electronic pointing device, wherein generating the stereo haptic effect comprises:
in accordance a determination that the pose is a third pose:
generating the first haptic effect at the first end of the electronic pointing device with a first weighting factor; and
generating the second haptic effect at the second end of the electronic pointing device with second weighting factor; and
in accordance with a determination that the pose is a fourth pose, different from the third pose:
generating the first haptic effect at the first end of the electronic pointing device with a third weighting factor, different from the first weighting factor; and
generating the second haptic effect at the second end of the electronic pointing device with a fourth weighting factor, different from the second weighting factor.

8. The method of claim 1, wherein the method further comprises:
in accordance with a determination that the pose satisfies one or more criteria, including a criterion that the pose is a third pose, and including a criterion that a gaze of the user is at a first location in the three-dimensional environment, generating a third haptic feedback at the electronic pointing device; and
in accordance with a determination that the pose satisfies one or more criteria, including a criterion that the pose is the third pose, and including a criterion that the gaze of the user is at a second location, different from the first location, in the three-dimensional environment, generating a fourth haptic feedback at the electronic pointing device, different from the third haptic feedback.

9. An electronic pointing device, the electronic pointing device comprising:
one or more sensors, wherein the one or more sensors are configured to detect touch inputs applied to the electronic pointing device;
a haptic feedback engine, wherein the haptic feedback engine is configured to generate a haptic feedback at the electronic pointing device; and
one or more processors;
a memory; and
one or more programs, wherein the one or more programs are stored in the memory and configured to be executed by the one or more processors, the one or more programs including instructions for:
while the electronic pointing device is in communication with an electronic device presenting a three-dimensional environment including virtual content:
receiving an indication to generate a haptic feedback at the haptic feedback engine in accordance with an interaction with the three-dimensional environment using the electronic pointing device;
receiving an indication of a pose of a portion of a user of the electronic pointing device directed to the electronic pointing device; and
in response to receiving the indication to generate the haptic feedback and the indication of the pose of the portion of the user directed to the electronic pointing device:
in accordance a determination that the pose is a first pose, generating a first haptic feedback at the electronic pointing device; and
in accordance with a determination that the pose is a second pose, different from the first pose, generating a second haptic feedback, different from the first haptic feedback, at the electronic pointing device.

10. The electronic pointing device of claim 9, wherein the received indication of the pose of the portion of the user includes an indication of a location on the electronic pointing device where the portion of the user is interacting with the electronic pointing device.

11. The electronic pointing device of claim 9, wherein the received indication of the pose of the portion of the user includes an indication of an orientation of the portion of the user with respect to the electronic pointing device.

12. The electronic pointing device of claim 9, wherein the received indication of the pose of the portion of the user includes an indication of a force being applied to the electronic pointing device by the portion of the user.

13. The electronic pointing device of claim 9, wherein the received indication of the pose of the portion of the user includes an indication of a pose of a hand of the user that is holding the electronic pointing device, and an indication of a pose of a second hand of the user that is not holding the electronic pointing device.

14. The electronic pointing device of claim 9, wherein one or more of the first haptic feedback and the second haptic feedback include a stereo haptic effect generated at the electronic pointing device, and wherein the stereo haptic effect is generated at one or more of a first end and a second end of the electronic pointing device.

15. The electronic pointing device of claim 14, wherein the stereo haptic effect includes generating a first haptic effect at the first end, and generating a second haptic effect at the second end of the electronic pointing device, wherein generating the stereo haptic effect comprises:
in accordance a determination that the pose is a third pose:
generate the first haptic effect at the first end of the electronic pointing device with a first weighting factor; and
generate the second haptic effect at the second end of the electronic pointing device with second weighting factor; and
in accordance with a determination that the pose is a fourth pose, different from the third pose:
generate the first haptic effect at the first end of the electronic pointing device with a third weighting factor, different from the first weighting factor; and
generate the second haptic effect at the second end of the electronic pointing device with a fourth weighting factor, different from the second weighting factor.

16. The electronic pointing device of claim 9, wherein the one or more programs including instructions for:
in accordance with a determination that the pose satisfies one or more criteria, including a criterion that the pose is a third pose, and including a criterion that a gaze of the user is at a first location in the three-dimensional environment, generating a third haptic feedback at the electronic pointing device; and
in accordance with a determination that the pose satisfies one or more criteria, including a criterion that the pose is the third pose, and including a criterion that the gaze of the user is at a second location, different from the first location, in the three-dimensional environment, generating a fourth haptic feedback at the electronic pointing device, different from the third haptic feedback.

17. A non-transitory computer readable storage medium storing one or more programs, the one or more programs comprising instructions, which when executed by one or more processors of an electronic device, cause the electronic device to perform a method comprising:
at an electronic device in communication with one or more displays and one or more input devices, wherein the one or more input devices include an electronic pointing device:
while a user of the electronic device is interacting with a three-dimensional environment using the electronic pointing device, receiving an indication of a pose of a portion of the user directed to the electronic pointing device;
in response to receiving the indication of the pose of the portion of the user directed to the electronic pointing device:
in accordance a determination that the pose is a first pose, generating a first haptic feedback at the electronic pointing device; and
in accordance with a determination that the pose is a second pose, different from the first pose, generating a second haptic feedback, different from the first haptic feedback, at the electronic pointing device.

18. The non-transitory computer readable storage medium of claim 17, wherein the received indication of the pose of the portion of the user includes an indication of a location on the electronic pointing device where the portion of the user is interacting with the electronic pointing device.

19. The non-transitory computer readable storage medium of claim 17, wherein the received indication of the pose of the portion of the user includes an indication of an orientation of the portion of the user with respect to the electronic pointing device.

20. The non-transitory computer readable storage medium of claim 17, wherein the received indication of the pose of the portion of the user includes an indication of a force being applied to the electronic pointing device by the portion of the user.

21. The non-transitory computer readable storage medium of claim 17, wherein the received indication of the pose of the portion of the user includes an indication of a pose of a hand of the user that is holding the electronic pointing device, and an indication of a pose of a second hand of the user that is not holding the electronic pointing device.

22. The non-transitory computer readable storage medium of claim 17, wherein one or more of the first haptic feedback and the second haptic feedback include a stereo haptic effect generated at the electronic pointing device, and wherein the stereo haptic effect is generated at one or more of a first end and a second end of the electronic pointing device.

23. The non-transitory computer readable storage medium of claim 22, wherein the stereo haptic effect includes generating a first haptic effect at the first end, and generating a second haptic effect at the second end of the electronic pointing device, wherein generating the stereo haptic effect comprises:
in accordance a determination that the pose is a third pose:
generate the first haptic effect at the first end of the electronic pointing device with a first weighting factor; and
generate the second haptic effect at the second end of the electronic pointing device with second weighting factor; and
in accordance with a determination that the pose is a fourth pose, different from the third pose:
generate the first haptic effect at the first end of the electronic pointing device with a third weighting factor, different from the first weighting factor; and
generate the second haptic effect at the second end of the electronic pointing device with a fourth weighting factor, different from the second weighting factor.

24. The non-transitory computer readable storage medium of claim 17, wherein the one or more programs including instructions for:
in accordance with a determination that the pose satisfies one or more criteria, including a criterion that the pose is a third pose, and including a criterion that a gaze of the user is at a first location in the three-dimensional environment, generating a third haptic feedback at the electronic pointing device; and
in accordance with a determination that the pose satisfies one or more criteria, including a criterion that the pose is the third pose, and including a criterion that the gaze of the user is at a second location, different from the first location, in the three-dimensional environment, generating a fourth haptic feedback at the electronic pointing device, different from the third haptic feedback.
